(19) United States
(12) Patent Application Publication
(10) Pub. No.: US 2021/0091484 A1
(43) Pub. Date: Mar. 25, 2021

(54) ELECTRICAL CONNECTION ARRANGEMENT COMPRISING A BUSBAR HAVING A CONDUCT ARRANGEMENT, WHICH IS CONNECTED TO THE SAID BUSBAR, AND A CLIP ELEMENT

(71) Applicant: TE Connectivity Germany GmbH, Bensheim (DE)

(72) Inventor: Thorsten Callies, Bensheim (DE)

(73) Assignee: TE Connectivity Germany GmbH, Bensheim (DE)

(21) Appl. No.: 17/031,036

(22) Filed: Sep. 24, 2020

(30) Foreign Application Priority Data
Sep. 24, 2019 (DE) 102019125675.5

(51) Int. Cl. H01R 4/48; H01R 4/40

(52) U.S. Cl. CPC H01R 4/4809; H01R 4/40

(57) ABSTRACT

An electrical connection arrangement includes a busbar having a first contact area, a conductor arrangement having a second contact area abutting the first contact area and electrically connecting the conductor arrangement to the busbar, the conductor arrangement including at least one current-conductor plate, and a clip element. The clip element has a first spring limb bearing on a bottom side of the busbar, a second spring limb resting on a top side of the conductor arrangement, and a connecting section connecting the first spring limb and the second spring limb. The first spring limb and the second spring limb press the busbar and the conductor arrangement against one another at the first contact area and the second contact area to create a mechanical connection between the busbar and the conductor arrangement.

### CROSS-REFERENCE TO RELATED APPLICATION

This application claims the benefit of the filing date under 35 U.S.C. § 119(a)-(d) of German Patent Application No. 102019125675.5, filed on Sep. 24, 2019.

### FIELD OF THE INVENTION

The present invention relates to an electrical connection arrangement and, more particularly, to an electrical connection arrangement for connecting a conductor arrangement to a bus bar.

### BACKGROUND

Busbars are used in various technical applications for constructing a local infrastructure for current distribution. Busbars which are designed in the form of relatively thick and rigid current conductors often form the backbone of the local infrastructure for current distribution, to which other current conductors are connected for further current distribution. On account of their dimensions, busbars are generally suitable for conducting high currents and powers.

Amongst other things, busbars in electrified vehicles are involved in forwarding electric currents from a battery assembly to corresponding power components, such as an electric drive motor for example. Because a battery assembly of this kind typically consists of a large number of individual battery cells, busbars are used here. The busbars are arranged directly on the battery assembly and are separately connected to a plurality of battery cells or a plurality of groups of battery cells.

In the case of electrified vehicles which, in addition to exclusively electrically driving vehicles, also encompass hybrid vehicles with an electric drive, the use of busbars of this kind requires particularly secure and reliable electrical and mechanical connection between the busbar and the current conductor connected to the busbar. Furthermore, a corresponding connection arrangement should be designed to be as flat as possible on account of the small amount of installation space available. The connection techniques which are typically used for busbars, such as screw connection, have proven to be particularly unsuitable and furthermore also quite complicated in terms of production.

### SUMMARY

An electrical connection arrangement includes a busbar having a first contact area, a conductor arrangement having a second contact area abutting the first contact area and electrically connecting the conductor arrangement to the busbar, the conductor arrangement including at least one current-conductor plate, and a clip element. The clip element has a first spring limb bearing on a bottom side of the busbar, a second spring limb resting on a top side of the conductor arrangement, and a connecting section connecting the first spring limb and the second spring limb. The first spring limb and the second spring limb press the busbar and the conductor arrangement against one another at the first contact area and the second contact area to create a mechanical connection between the busbar and the conductor arrangement.

### BRIEF DESCRIPTION OF THE DRAWINGS

The invention will now be described by way of example with reference to the accompanying Figures, of which:

FIG. 1 is a perspective view of a connection arrangement according to an embodiment;

FIG. 2 is a side view of the connection arrangement of FIG. 1;

FIG. 3 is a perspective view of a clip element of the connection arrangement of FIG. 1;

FIG. 4 is an exploded perspective view of a plurality of current conductors of the connection arrangement of FIG. 1;

FIG. 5 is a sectional perspective view of the plurality of current conductors of FIG. 4;

FIG. 6 is a sectional perspective view of the plurality of current conductors of FIG. 4 prior to mounting of the clip element;

FIG. 7 is a sectional perspective view of the connection arrangement of FIG. 1;

FIG. 8 is an exploded perspective view of a plurality of current conductors according to another embodiment;

FIG. 9 is a perspective view of a connection arrangement according to another embodiment with a clip element having a latching structure;

FIG. 10 is a perspective view of a connection arrangement according to another embodiment with a clip element having a latching structure according to another embodiment;

FIG. 11 is a perspective view of a connection arrangement according to another embodiment with a clip element having a latching structure according to another embodiment;

FIG. 12 is a side view of the connection arrangement of FIG. 11;

FIG. 13 is a perspective view of a clip element according to another embodiment;

FIG. 14 is a perspective view of a connection arrangement with the clip element of FIG. 13;

FIG. 15 is a perspective view of a clip element according to another embodiment; and

FIG. 16 is a perspective view of a connection arrangement according to another embodiment.

### DETAILED DESCRIPTION OF THE EMBODIMENT(S)

Features and exemplary embodiments as well as advantages of the present invention are explained in more detail below with reference to the drawings. It is understood that the embodiments do not exhaust the scope of the present invention. It is further understood that some or all of the features described below can be combined with each other in other ways.

A connection arrangement 100 according to an embodiment, as shown in FIG. 1, comprises a busbar 110, a conductor arrangement 120 which is connected to the busbar 110 and includes a pair of current-conducting plates 130, 140 which are arranged one above the other, and a clip element 160 which connects the conductor arrangement 120 and the busbar 110 to one another.

The busbar 110, which is of substantially rectangular design in the embodiment shown in FIG. 1, has a flat top side 111 on which a contact area 116 is located in a contact region 115 of the busbar 110. The contact area 116 serves here as a support area for the conductor arrangement 120 and, in the assembled state of the electrical connection arrangement 100 shown here, is covered by the conductor arrangement 120. Here, the conductor arrangement 120, by way of a contact area 122 which is arranged on its likewise flat bottom side 133, rests on the busbar 110. Since the conductor arrangement 120 is designed in the form of a stack 121 comprising two strip-like current-conducting plates 130, 140, which are arranged one above the other, in the present example, the contact area 122 of the conductor arrangement 120 is located on the bottom side 133 of the lower current-conducting plate 130.

In order to fix the conductor arrangement 120 to the busbar 110, the electrical connection arrangement 100 comprises the clip element 160 shown in FIG. 1 which, in the assembled state of the electrical connection arrangement 100, comprises the busbar 110 and the conductor arrangement 120 arranged on the busbar 110 and presses them against one another by way of their contact areas 116, 122. To this end, the clip element 160 has two elastically deflectable spring limbs 170, 180 which are connected to one another by a connecting section 190. The first spring limb 170 has a top side 171 and the second spring limb 180 has a bottom side 181.

The connection of a plurality of current-conducting plates 130, 140 which are arranged one above the other to the busbar 110 renders possible a particularly space-saving arrangement. This concept is advantageous particularly when a large number of battery cells are connected, as may be the case in a battery assembly of an electrified vehicle. In an embodiment, the busbar 110 is part of a battery assembly which comprises a plurality of batteries. Here, at least one current-conducting plate 130, 140 is designed as a current-tapping plate for a battery of the battery assembly.

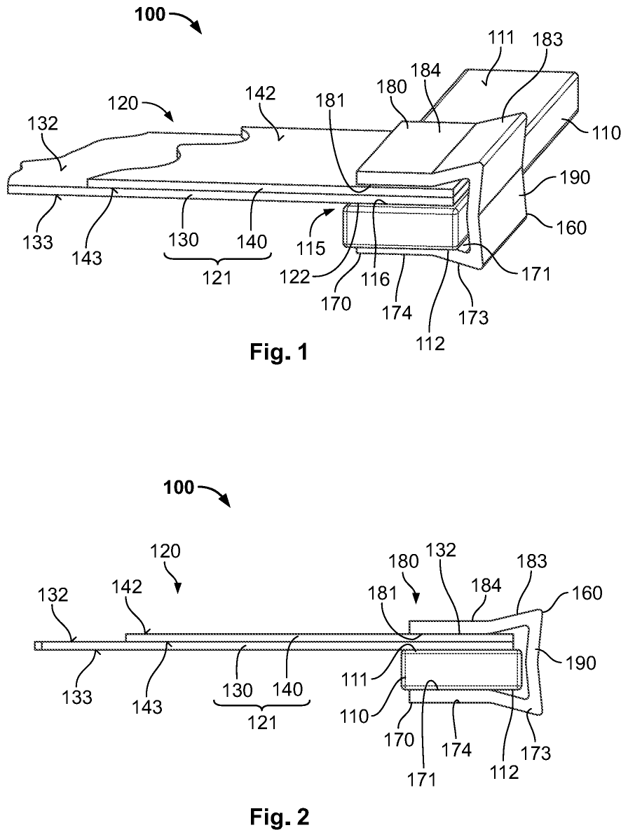

As shown in FIG. 2, the clip element 160 presses, by way of its lower spring limb 170, against the bottom side 112 of the busbar 110 from below and, by way of its upper spring limb 180, against the top side 132 of the conductor arrangement 120 from above.

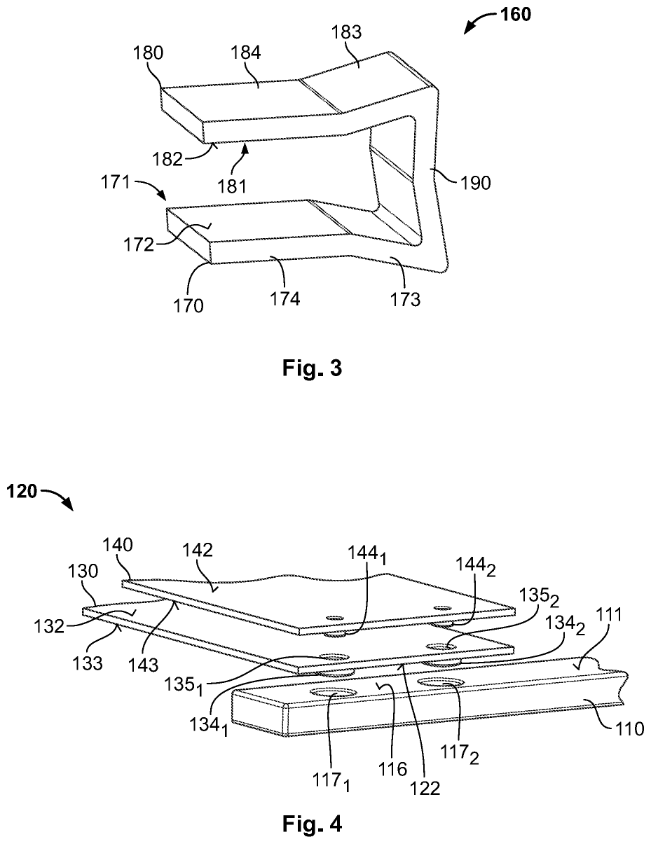

FIG. 3 shows a view of a detail of the clip element 116 from FIG. 2. Here, the clip element 116 is located in an elastically pretensioned state, which corresponds to the assembled state, with spread spring limbs 170, 180. The spring element 116 shown by way of example here is formed in the form of a bent metal strip (e.g. spring steel). However, in principle, the spring element 116 can also be realized from a different material and in a form other than that shown here.

As shown in FIG. 3, the spring limbs 170, 180 of the clip element 160 each have a first section 173, 183 which springs up from the connecting section 190 and a second section 174, 184 which adjoins the first section 173, 183. The first sections 173, 183 of the two spring limbs 170, 180 run in a manner slightly bent in relation to one another, so that they do not come into contact with the busbar 110 and the conductor arrangement 120, but rather serve substantially as elastically deflectable spring elements of the spring limbs 170, 180. Second sections 174, 184 adjoin the first sections 173, 183, which second sections 174, 184 are in turn each bent slightly outwards and each have a flat contact-pressure area 172, 182 in the shown embodiment. Depending on the application, the contact-pressure areas 172, 182 can be specially structured in order to, for example, facilitate mounting of the clip element 160 with the aid of particularly smooth contact-pressure areas 172, 182 or prevent the mounted clip element 160 from slipping with the aid of specially structured surfaces.

In order to prevent lateral displacement of the conductor arrangement 120 or the current-conducting plates 130, 140 in relation to the busbar 110, the components involved are connected to one another in an interlocking manner. To this end, the busbar 110 and/or the conductor arrangement 120 have a corresponding structuring on their respective contact areas 116, 122, which structurings interact in an interlocking manner with the respectively complementary contact area 122, 116 or a structuring of the respectively complementary contact area 122, 116. In order to also suppress lateral displacement of the individual current-conducting plates 130, 140 relative to one another in a conductor arrangement 120 which has a plurality of current-conducting plates 130, 140 which are arranged one above the other, corresponding surface structurings are also provided on the contact areas of the current-conducting plates 130, 140.

As shown in FIG. 4, in the present example, the first current-conducting plate 130 has, on its bottom side 133 which forms the contact area 122 of the conductor arrangement 120, two surface structures 1341, 1342 in the form of stud- or cup-like raised portions which, in the assembled state of the electrical connection arrangement 100, engage in an interlocking manner into two recesses 1171, 1172 of corresponding design on the complementary contact area 116 of the busbar 110. The second current-conducting plate 140 also has, on its bottom side 143, two surface structures 1441, 1442 in the form of stud- or cup-like raised portions which, in the assembled state of the electrical connection arrangement 100, engage in an interlocking manner into two recesses 1351, 1352 of corresponding design on the top side 132 of the first current-conducting plate 140.

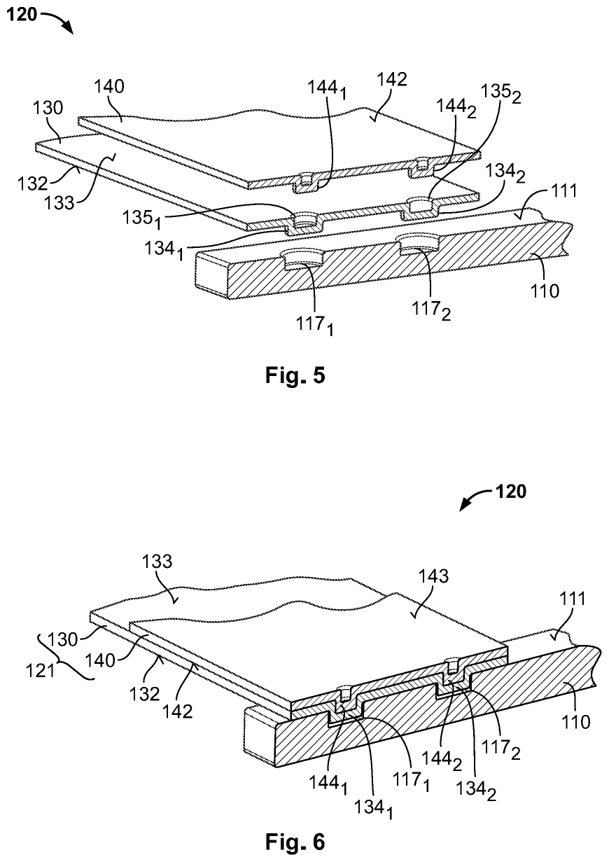

As shown in FIG. 5, the surface structures 1341, 1342, 1441, 1442 are of cup-like design in the shown embodiment, wherein the stud-like raised portions 1341, 1342, 1441, 1442, which each protrude downwards, are each positioned directly above the respectively associated recess 1171, 1172, 1351, 1352.

FIG. 6 shows a sectional illustration through an arrangement, which has already been preassembled, comprising the two current-conducting plates 130, 140 and the busbar 110. Depending on the application, preassembly in this way of the two current-conducting plates 130, 140 with one another or of the conductor arrangement 120 which is formed from the current-conducting plates 130, 140 and of the busbar 110 takes place in a different way. In the simplest case, the conductor structures 110, 130, 140 are simply placed one on the other. The conductor structures 110, 130, 140 can further also be preliminarily fixed by being pressed together, wherein surface structures which may be present are pressed one into the other. In principle, any suitable connecting methods for electrical conductors can also be used for preassembly of the conductor structures 110, 130, 140. The connecting methods include, amongst others, soldering or welding, such as ultrasonic welding or electric welding for example.

In the exemplary embodiment shown in FIG. 6, the stud-like raised portions 1341, 1342 of the first current-conducting plate 130 which each protrude downwards engage in an interlocking manner into the associated recesses 1171, 1172 on the top side 111 of the busbar 110. Analogously, the cup-like raised portions 1441, 1442 on the top side 142 of the second current-conducting plate 140 which protrude downwards engage in an interlocking manner into the recesses 1351, 1352 which are formed on the top side 133 of the first current-conducting plate 130.

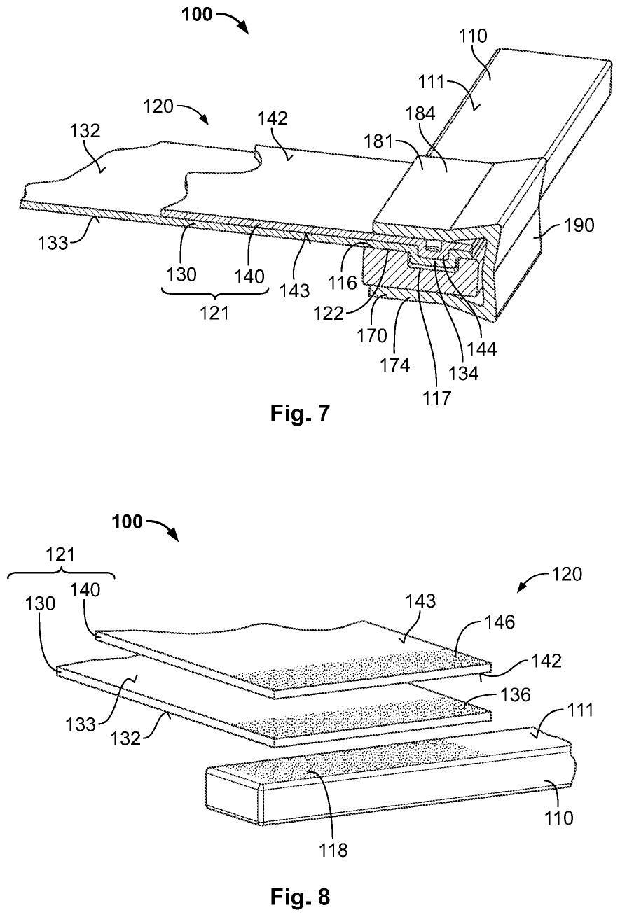

Owing to the interlocking engagement of the stud-like raised portions 1341, 1342, 1441, 1442 into the respectively associated recesses 1171, 1172, 1351, 1352, the conductor structures 130, 140, 110 involved are secured against lateral displacement. As is clear from the sectional illustration of FIG. 7, the clip element 160, with the aid of its two spring limbs 170, 180, presses the connection partners 110, 130, 140 against one another and in so doing prevents the stud-like raised portions 1341, 1342, 1441, 1442 from falling out of the recesses 1171, 1172, 1351, 1352. This results in a particularly secure mechanical and electrical connection between the current-conducting plates 130, 140 and the busbar 110.

In principle, the dimensions of the stud-like raised portions 1341, 1342, 1441, 1442 and of the corresponding recesses 1171, 1172, 1351, 1352 are matched to one another. In particular, the dimensions of the stud-like raised portions 1341, 1342, 1441, 1442 can be designed with an accurate fit with respect to the dimensions of the respectively associated recesses 1171, 1172, 1351, 1352, as a result of which a fixed connection between the current-conducting plates 130, 140 and the busbar 110 situated therebeneath is achieved. Here, slight overdimensioning of the stud-like raised portions 1341, 1342, 1441, 1442 or slight underdimensioning of the associated recesses 1171, 1172, 1351, 1352 can have the effect that a flow of material is induced in the relevant surface structures by pressing together the current-conducting plates 130, 140 and the busbar 110, by way of which flow of material oxide layers which may be present on the surface of the components involved are broken up and improved electrical contact between the conductors involved is achieved.

In principle, the stud-like raised portions 1341, 1342, 1441, 1442 can also be slightly underdimensioned with respect to the associated recesses 1171, 1172, 1351, 1352. This can facilitate mounting of the current-conducting plates 130, 140.

The use of cup-like surface structures 1341, 1342, 1441, 1442 on the current-conducting plates 130, 140 has the advantage that they can be produced in a relatively simple manner with the aid of a deep-drawing process. However, in principle, it is also possible to produce the corresponding raised portions and recesses with the aid of other production processes, for example by removing material with the aid of a cutting process, too.

In addition or as an alternative to using surface structures, an interlocking connection between the current-conducting plates 130, 140 and the busbar 110 can also be achieved by special structuring of the respective contact areas. FIG. 8 shows, by way of example, an embodiment of the electrical connection arrangement 100 in which the busbar 110 and the two current-conducting plates 130, 140 have corresponding surface structures 118, 136, 146. The surface structures 118, 136, 146 have a specified roughness. Surfaces of this kind generally have irregular microstructurings which are created, for example, by embossing, eroding, sandblasting, grinding or other methods for roughening or structuring the respective surfaces 111, 132, 133, 142, 143. However, in principle, a suitable surface structuring can also comprise regular microstructures, such as channels, teeth or comparable structures for example. Structures of this kind can be created, for example, by an embossing process. FIG. 8 shows the respective surface structurings 118, 136, 146 respectively only on the top sides 111, 133, 143 of the conductor structures 110, 130, 140. However, in principle, the bottom sides 112, 133, 143 of the respective conductor structure 110, 130, 140 can also have corresponding surface structuring.

As already described in connection with the dimensioning of the stud-like structures 1341, 1342, 1441, 1442 and the associated recesses 1171, 1172, 1351, 1352, it may be advantageous to break up oxide layers which may be present on the contact areas of the current conductors 110, 130, 140 in order to improve the electrical contact between the current conductors 110, 130, 140. This can also be done with the aid of special structures which are designed as part of the structuring on at least one of the contact areas of the current conductors 110, 130, 140. As part of the assembly of the electrical connection arrangement 100, structures of this kind, which have sharp edges in an embodiment, can enter the corresponding contact area of the respective connection partner 110, 130, 140 when the conductor structures 110, 130, 140 are pressed together and in so doing ensure sufficient electrical contact between the connection partners 110, 130, 140. In addition to improved electrical contact, the ingress of structures of this kind into the respectively complementary contact area of the connection partner 110, 130, 140 also produces an interlocking connection between the two connection partners 110, 130, 140. This provides security against lateral displacement of the conductor structures 110, 130, 140.

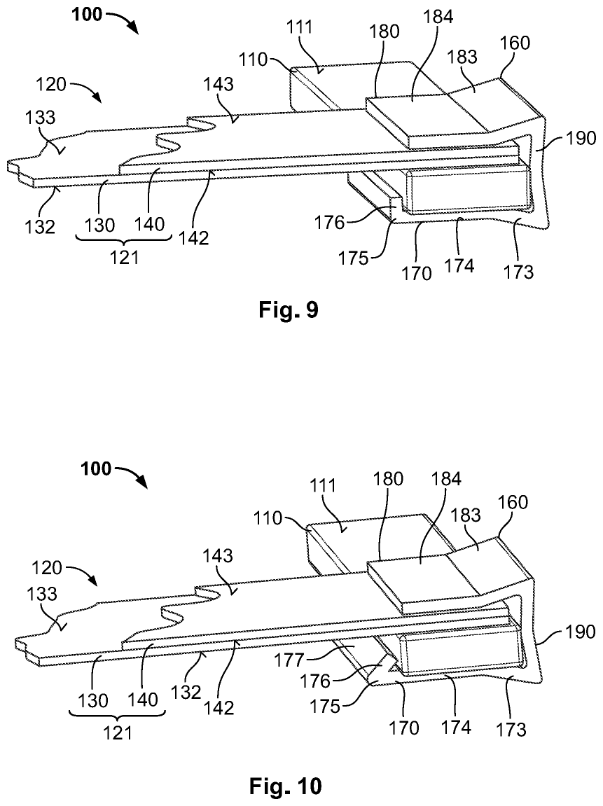

Corresponding mounting securing devices can be provided for securing the clip element 160 in its mounted position. These mounting securing devices can be designed, for example, in the form of one or more latching elements. FIG. 9 shows an exemplary embodiment of the clip element 160, the lower spring limb 170 of which has a corresponding latching element 176. The latching element 176, which is formed by a downwardly bent end section 175 of the lower spring limb 170 in the present example, engages around the busbar 110 in the mounted state of the clip element 160 and in this way secures the clip element 160 against unintentionally slipping or falling out.

FIG. 10 shows an alternative embodiment in which the latching element 176 which is arranged on the lower spring limb 170 of the clip element 160 has been created by more intense bending of the end section 175 of the respective spring limb 170. Here, the latching element 176 forms an acute angle with the central section 174 of the lower spring limb 170. In this variant, the outer face 177 of the latching element 176 forms a kind of ramp by way of which mounting of the clip element 160 onto the preassembled arrangement comprising the busbar 110 and the current-conducting plates 130, 140 is made easier.

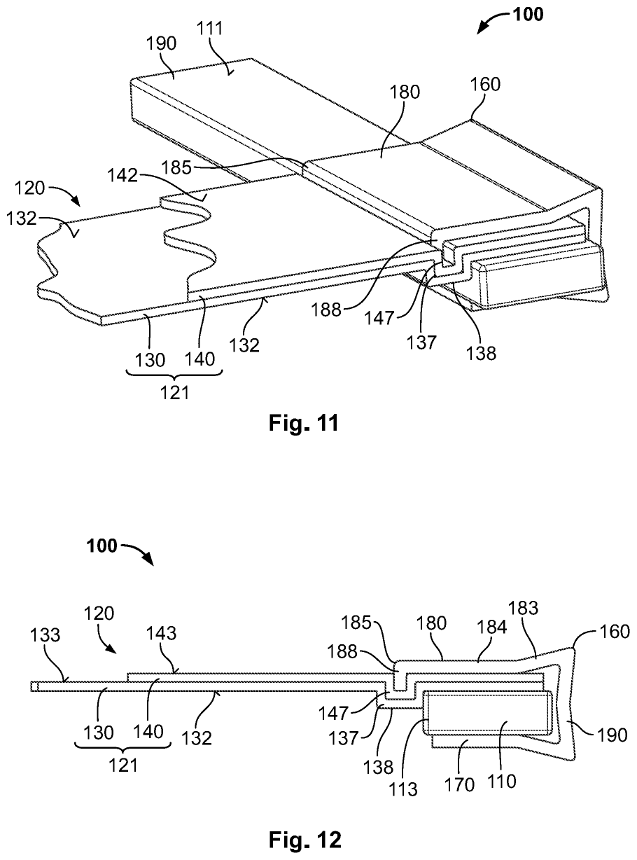

The clip element 160 can also be fixed, in principle, with a latching element 188 which is formed on the upper spring limb 180. In this respect, FIG. 11 shows an electrical connection arrangement 100 of corresponding design in which the upper spring limb 180 has a latching element 188 which has been created by bending the end section 185 of the upper spring limb 180. As is clear from FIG. 12, which shows a side view of the electrical connection arrangement 100 from FIG. 11, the latching element 188, in the mounted state of the clip element 160, engages in an interlocking manner into a groove 137, 147 which is arranged on the top side 142 of the conductor arrangement 120. The groove 137, 147 is created, for example, by a bending or deep-drawing process of the current-conducting plates 130, 140. Owing to the production process for the groove 137, 147, a raised portion 138 is produced on the bottom side 132 of the first current-conducting plate 130, which raised portion 138, in the assembled state of the electrical connection arrangement 100, bears against a side wall 113 of the busbar 110 which faces the raised portion 138. As a result, the clip element 160 is not directly, but indirectly, latched to the busbar 110, as a result of which the clip element 160 is correspondingly mechanically secured in its mounting position and therefore the entire electrical connection arrangement 100 is correspondingly mechanically secured.

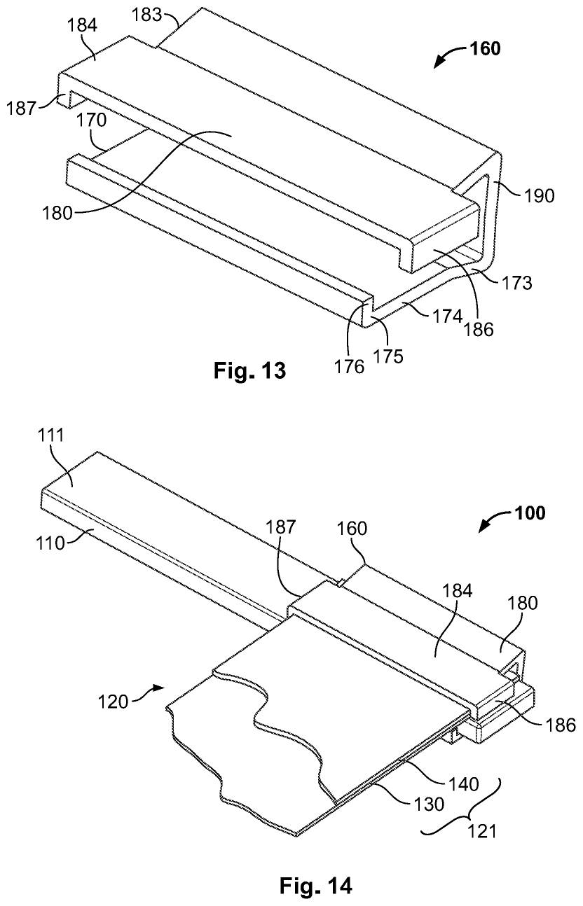

FIG. 13 shows a further variation of the clip element 160 in which the upper spring limb 180, in its second section 184, has two lateral wing structures 186, 187 which protrude downwards. The lateral wing structures 186, 187, in an embodiment, are created by bending structures, which protrude out of the upper spring limb 180 in the longitudinal direction of the busbar 110, in the direction of the lower spring limb 170 serve here as lateral securing devices for securing the electrical connection arrangement 100 against lateral movement of the components involved. A mounted state of the clip element 160 from FIG. 13 is shown in FIG. 14. It is clear here that the lateral wing structures 186, 187 which are arranged on the upper spring limb 180 of the clip element 160 laterally enclose the two current-conducting plates 130, 140 and in this way prevent lateral movement of these components in the longitudinal direction of the busbar 110 in an effective manner. At the same time, the two lateral wing structures 186, 187 also prevent the clip element 160 from unintentionally laterally slipping in the longitudinal direction of the busbar 110. Overall, the security of the mechanical and electrical connection between the conductor arrangement 120, which is formed from the current-conducting plates 130, 140, and the busbar 110 can be improved with the aid of the lateral wing structures 186, 187.

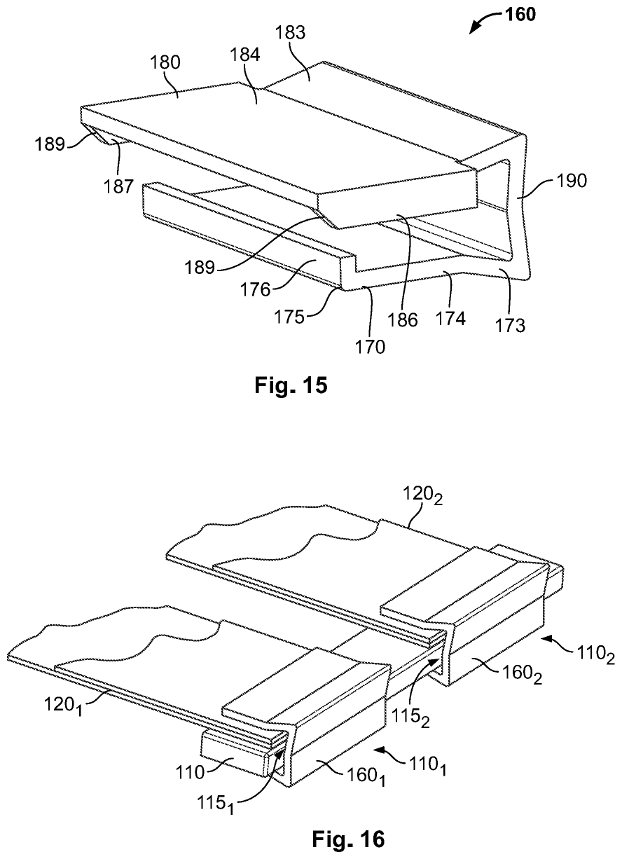

FIG. 15 shows a variation of the clip element 160 from FIG. 11. Here, the central section 184 of the upper spring limb 180 and the lateral wing structures 186, 187 which are arranged thereon extend in the direction of extent of the upper spring limb 170. At the same time, the end sections of the two lateral wing structures 186, 187, which end sections protrude in the direction of extent of the upper spring limb 170, have suitable chamfers 189, the oblique faces of which form suitable ramps for simplified mounting of the clip element 160 onto a preassembled arrangement comprising the busbar 110 and the current-conducting plates 130, 140 of the conductor arrangement 120.

FIG. 16 shows a busbar 110 which is designed as a busbar for a plurality of conductor arrangements 1201, 1202. Here, the conductor arrangements 1201, 1202 which are each formed from two current-conducting plates are arranged in different contact sections 1151, 1152 of the busbar 110 and fastened to the common busbar 110 by a separate clip element 1601, 1602 in each case.

Although the invention has been illustrated and described in more detail by the exemplary embodiments, the invention is not limited by the disclosed examples. Rather, other variations and combinations of features can be derived therefrom by a person skilled in the art, without departing from the scope of protection of the invention.

The invention provides a possible way of connecting conductor arrangements 120 and busbars 110 which, in addition to a sufficient degree of security and reliability and a small amount of installation space, also renders possible relatively simple production and assembly. The clip element 160 allows flat conductor structures to be fastened to the busbar 110 in a particularly simple and rapid manner.

What is claimed is:

1. An electrical connection arrangement, comprising:
a busbar having a first contact area;
a conductor arrangement having a second contact area abutting the first contact area and electrically connecting the conductor arrangement to the busbar, the conductor arrangement including at least one current-conductor plate; and
a clip element having a first spring limb bearing on a bottom side of the busbar, a second spring limb resting on a top side of the conductor arrangement, and a connecting section connecting the first spring limb and the second spring limb, the first spring limb and the second spring limb press the busbar and the conductor arrangement against one another at the first contact area and the second contact area to create a mechanical connection between the busbar and the conductor arrangement.

2. The electrical connection arrangement of claim 1, wherein the second contact area has at least one surface structure interacting with a complementary surface structure on the first contact area in an assembled state of the electrical connection arrangement to interlock the conductor arrangement and the busbar.

3. The electrical connection arrangement of claim 2, wherein the surface structure on the second contact area is a stud-like or cup-like raised portion.

4. The electrical connection arrangement of claim 3, wherein the complementary surface structure on the first contact area is a corresponding recess.

5. The electrical connection arrangement of claim 1, wherein the conductor arrangement is a stack including a first current-conducting plate and a second current-conducting plate, the second contact area is arranged on a bottom side of the first current-conducting plate.

6. The electrical connection arrangement of claim 5, wherein the second spring limb exerts a defined pressure onto a top side of the second current-conductor plate, pressing the second current-conducting plate toward the first current-conducting plate and the second contact area against the first contact area.

7. The electrical connection arrangement of claim 6, wherein the first current-conducting plate has a cup-like surface structure that forms a recess on a top side of the first current-conducting plate.

8. The electrical connection arrangement of claim 7, wherein the recess of the first current-conducting plate forms an interlocking receptacle for a stud-like or a cup-like surface structure of the second current-conducting plate arranged directly above the first current-conducting plate.

9. The electrical connection arrangement of claim 1, wherein at least one of the first contact area and the second contact area has a specified roughness limiting a lateral movement between the conductor arrangement and the busbar.

10. The electrical connection arrangement of claim 1, wherein at least one of the first spring limb and the second spring limb has a latching structure engaging in an interlocking manner around the busbar.

11. The electrical connection arrangement of claim 10, wherein the latching structure is formed by a bent end section of the at least one of the first spring limb and the second spring limb.

12. The electrical connection arrangement of claim 11, wherein the bent end section forms an acute angle with an adjoining section of the second spring limb.

13. The electrical connection arrangement of claim 1, wherein the second spring limb has a pair of lateral wing structures extending in a direction of the first spring limb, the lateral wing structures suppress a lateral movement of the conductor arrangement.

14. The electrical connection arrangement of claim 1, wherein the busbar is a busbar of a battery assembly having a plurality of batteries.

15. The electrical connection arrangement of claim 14, wherein the at least one current-conducting plate is a current-tapping plate for a battery of the battery assembly.

16. A clip element, comprising:
a first spring limb bearing on a bottom side of a busbar;
a second spring limb resting on a top side of a conductor arrangement;
and a connecting section connecting the first spring limb and the second spring limb, the first spring limb and the second spring limb press the busbar and the conductor arrangement against one another at a first contact area of the busbar and a second contact area of the conductor arrangement to create a mechanical connection between the busbar and the conductor arrangement.

17. A busbar for a connection arrangement, comprising:
a first contact area abutting a second contact area of a conductor arrangement and electrically connected to the conductor arrangement, a clip element having a first spring limb bearing on a bottom side of the busbar, a second spring limb resting on a top side of the conductor arrangement, and a connecting section connecting the first spring limb and the second spring limb presses the busbar and the conductor arrangement against one another at the first contact area and the second contact area to create a mechanical connection between the busbar and the conductor arrangement.

18. A conductor arrangement for a connection arrangement, comprising:
at least one current-conducting plate having a first contact area abutting a second contact area of a busbar, the at least one current-conducting plate electrically connected to the busbar, a clip element having a first spring limb bearing on a bottom side of the busbar, a second spring limb resting on a top side of the at least one current-conducting plate, and a connecting section connecting the first spring limb and the second spring limb presses the busbar and the at least one current-conducting plate against one another at the first contact area and the second contact area to create a mechanical connection between the busbar and the at least one current-conducting plate.
